(19) United States
(12) Patent Application Publication
(10) Pub. No.: US 2007/0231688 A1
(43) Pub. Date: Oct. 4, 2007

(54) Component Comprising an Electron Collector and an Active Material, and the Use Thereof as a Battery Electrode

(75) Inventors: Sylvie Grugeon, Feuquieres (FR); Stephane Laruelle, Saveuse (FR); Jean-Marie Tarascon, Mennecy (FR)

Correspondence Address: MILLER, MATTHIAS & HULL, ONE NORTH FRANKLIN STREET, SUITE 2350, CHICAGO, IL, 60606, US

(73) Assignee: ELECTRICITE DE FRANCE, PARIS (FR)

(21) Appl. No.: 11/569,052

(22) PCT Filed: May 19, 2005
(86) PCT No.: PCT/FR05/01256

§ 371 Date: Nov. 13, 2006

(30) Foreign Application Priority Data
May 19, 2004 (FR) 0405486

(51) Int. Cl. H01M 4/02

(52) U.S. Cl. 429/209; 29/623.1

(57) ABSTRACT

The invention relates to a component for an accumulator or for a supercondenser, said component comprising at least one election collector and an active material containing at least one transition metal and having been formed at least partially from the collector. The active material is at least partially at the surface of the electron collector, and at least part of the active material comprises nanoparticles of at least one compound of the transition metal or agglomerates of said nanoparticles, the nanoparticles having an average size of between 1 and 1,000 nm, and the agglomerates of nanoparticles having an average size of between 1 and 10,000 nm. The invention also relates to a method for producing one such component, and to a supercondenser and a preferably lithium electrochemical accumulator comprising one such component

The invention relates to a component, which may be termed an “electrode-collector”, comprising at least one electron collector and active material. The invention also relates to the process for manufacturing said component and to the use thereof, usually as a battery electrode, in particular a lithium battery electrode.

The extraordinary growth of the portable electronic equipment market encouraged, upstream, an ever greater emulation in the field of rechargeable batteries or accumulators. Apart from the mobile telephone market, which is experiencing the lightening growth, sales of portable computers, growing by 20% per year, entail new requirements as regards the performance of their power supplies. To this should also be added the expansion of the market for camcorders, digital cameras, personal CD players, cordless tools and many games which increasingly often require rechargeable batteries. Finally, it is probable that the 21st century will see considerable development in electric vehicles and hybrid vehicles, the emergence of which results from the increasingly stringent international regulations as regards polluting emissions and the greenhouse effect of internal combustion engines,

Although the accumulator market at the present time is very attractive, it is however important for the correct choice to be made so as to be able to be positioned for the new generation of electronic equipment. In fact, it is the progress in electronics that dictate the specification for today's accumulators. To the present requirements for accumulators to be of longer life should be added, because of miniaturization, the desire to have thinner and more flexible accumulators.

The lithium metal (or Li metal) terminology generally defines the technology in which the anode or negative electrode comprises the metal, the electrolyte contains lithium ions, and the cathode or positive electrode comprises at least one material that electrochemically reacts, reversibly, with lithium, The material that electrochemically reacts reversibly with lithium is, for example, an insertion material, which may or may not contain lithium. In general, the electrolyte contains lithium ions, whether the electrolyte is a liquid or a polymer charged with lithium salt—in the latter case, this is generally referred to as a dry polymer electrolyte.

The lithium ion (Li ion) terminology generally defines the technology in which the cathode comprises a lithium-containing insertion material, the anode comprises at least one material that electrochemically reacts reversibly with lithium, and the electrolyte contains lithium ions. The material that electrochemically reacts reversibly with lithium is for example an insertion material, which may or may not contain lithium, or carbon, In general, the electrolyte contains lithium ions, whether in liquid form or in the form of a liquid-impregnated polymer—in the latter case, this is generally referred to as a plastic electrolyte.

The lithium metal technology and the lithium ion technology are capable of providing the desired flexibility, but they remain at a high price owing to the nature of the materials employed and the insufficient level of safety, in the event of an internal or external fault, Moreover, the price and safety of lithium ion accumulators remain major obstacles for their commercialization in the form of batteries with a capacity of several kWh in the electric and hybrid vehicle market.

The inventors have found that, thanks to a component based on an active material and a collector, acting essentially as electrode without the addition of either a secondary conducting material or a compound of the binder type, it is possible to produce accumulators possessing performance levels, in terms of power and specific energy, which are comparable to or even higher than the accumulators of the prior art. This is more particularly so in the case of a lithium accumulator, whether this uses Li metal technology or Li ion technology.

The invention relates more particularly to the field of rechargeable batteries or secondary batteries or accumulators. But it may also relate to the field of lithium cells or primary batteries.

The component according to the invention is a component comprising at least one electron collector and electrochemically active material, said active material containing at least one metal belonging to the group of transition metals of Groups 4 to 12 of the Periodic Table of the Elements, preferably belonging to the group consisting of nickel, cobalt, manganese, copper, chromium and iron, even more preferably chromium, the active material having been at least partly, preferably almost entirely, formed from the collector and the active material being at least partly, preferably almost entirely, on the surface of the electron collector, and at least some of the active material comprising at least nanoparticles of at least one transition metal compound or agglomerates of said nanoparticles, the nanoparticles having a mean size of 1 to 1000 nm, preferably 10 to 300 nm, and the agglomerates of nanoparticles having a mean size of 1 to 10000 nm, preferably 10 to 3000 nm.

The term “collector” or “electron collector” is understood according to the invention to mean a part that collects electrons. The term “active material” or “electrochemically active material” is understood according to the invention to mean a material that may be conducting but not necessarily so, as it may conduct electrons by the tunnel effect, in which electrochemical activity (electrochemical reaction involving the exchange of electrons and ions with the active material) and/or electrocapacitive activity by charge (electron) accumulation occur. According to the invention, the term “component” (also called “electrode-collector”) is understood according to the invention to mean a component that exerts both a collector function and a conversion function whereby chemical energy is converted into electrical energy thanks to the active material. Thus, the term “electrode-collector” is understood according to the invention to mean an electron collector which generally has its own electrochemical activity in terms of capacity, that is to say it comprises electrochemically active material.

Thus, such a component according to the invention makes it possible advantageously to obtain a capacity (in the electrochemical sense) by immersing it in an electrolyte and cycling it, more particularly with respect to lithium.

The active material is, in a novel manner according to the invention, formed from the collector, that is to say generated by treatment of the collector, for example by treatment in air, and as will be explained in the manufacturing process below. Typically, the transition metal from the collector is converted by a treatment into a transition metal compound, present mainly on the surface of the collector.

Thus, according to the invention, the active material is not supplied from the outside in the form of a powder on a collector, by treatment with a binder or by deposition, as is known in the prior art. The extremely powerful technological novelty of the invention is that the component according to the invention may provide, particularly advantageously, an electrode function without the addition of binder or secondary electronic conductor, as in the prior art, even though such addition remains possible. Thus, the component according to the invention is not generally a composite material as in the prior art, and does not generally comprise an organic compound.

The invention therefore enormously simplifies the manufacture and the processing of supported electrodes according to the prior art, whether by facilitating their manufacture or by reducing their manufacturing cost, while still maintaining or even improving their mechanical value.

The nanoparticles are generally, and preferably, grouped together or clustered on the surface of the collector into agglomerates (of nanoparticles) or particles, the agglomerates having a mean size of 1 to 10000 nm, preferably 10 to 3000 nm, as has been demonstrated by scanning microscopy. All the nanoparticles, whether agglomerated or not, may thus advantageously form what is referred to as a “surface layer” according to the invention, The surface layer preferably consists mainly of such nanoparticles and/or such agglomerates of nanoparticles, but, more generally, it may also include other constituents. As a result, the nanoparticles advantageously help substantially increase the active area that is in contact with the electrolyte during cycling when the component according to the invention is used as an electrode. Said particles are generally, and particularly advantageously, distributed uniformly on the surface of the collector.

The term “nanostructured” is understood to mean according to the invention a rough and porous surface comprising, and preferably consisting mainly of, nanoparticles or agglomerates of nanoparticles as defined above. The component according to the invention is usually nanostructured.

The transition metal compound is generally an inorganic transition metal compound. Thus, the nanoparticles usually comprise, and preferably essentially consist of, at least one compound chosen from inorganic transition metal compounds, that is to say inorganic compounds comprising at least one transition metal, preferably as cation.

Preferably, said nanoparticles comprise, and preferably consist of, at least one compound chosen from transition metal chalcogenides, transition metal halides, and even more preferably chosen from transition metal chalcogenides. Preferably, according to the invention, the inorganic transition metal compound is a transition metal oxide.

The term “chalcogenide” is understood according to the invention to mean an inorganic compound derived from a chalcogen and the term “chalcogen” is understood according to the invention to mean an element chosen from the group formed by oxygen, sulfur, selenium and tellurium. Thus, chalcogenides comprise oxides. Preferably, according to the invention, a chalcogenide is an oxide or a sulfide, and even more preferably according to the invention a chalcogenide is an oxide. The term “halide” is understood usually, and according to the invention, to mean a fluoride, a chloride, an iodide or a bromide.

In one embodiment of the invention, the transition metal compound is of formula MₓO_{y}, in which 1≦x≦3 and 1≦y≦5, preferably 1≦y≦4, and M is at least one transition metal, the transition metal compound preferably being of formula chosen:
from the group formed by AB₂O₄ spinel structures, where A is at least one transition metal chosen from the group formed by Fe, Mn, Cr, Ni, Co and Cu, and B is at least one metal chosen from the group formed by Fe, Cr and Mn; and/or
from the group formed by sesquioxides M′₂O₃, where M′ is at least one transition metal chosen from the group formed by Fe, Mn, Cr, Ni, Co and Cu, the transition metal compound being even more preferably of formula Fe_{x′}Cr_{y′}Mn_{z′}O₄, where: 0≦x′≦1, 0≦z′≦1, and x′+y′+z′=3, and/or Cr₂O₃.

Preferably, the valency of M is 2 or 3, preferably 3. Preferably, the valency of M′ is 3. Compounds of formula Fe_{x′}Cr_{y′}Mn_{z′}O₄ encompass in particular compounds of formula Fe_{x′}Cr_{1-x′}Cr₂O₄.

According to one embodiment of the invention, the component comprises, at least partly preferably entirely, a surface layer formed predominantly from at least one transition metal compound, preferably an inorganic one and the surface layer preferably comprising, at least partly and preferably consisting mainly (i.e. generally at least 50% by weight) of, nanoparticles or agglomerates of nanoparticles of at least one transition metal compound, the nanoparticles and the agglomerates of nanoparticles being as defined above. The “surface layer” was defined above. Preferably, said inorganic compound is, as indicated above, a transition metal chalcogenide and/or a transition metal halide. Even more preferably, said inorganic compound is a transition metal oxide.

According to this embodiment of the invention, said surface layer generally has a thickness of 30 to 15000 nm, preferably 30 to 12000 nm.

According to one particularly preferred embodiment of the component according to the invention, the collector comprises a metal alloy containing chromium, for example an iron/chromium alloy. Preferably, the collector comprises stainless steel, that is to say it is generally composed of a single stainless steel or several stainless steels. The collector may also comprise a non-stainless steel.

An example of a collector is a stainless steel of the AISI 304 type, for example such as that sold by Goodfellow, which comprises many constituents (including at least 2 wt % Mn, at least 800 ppm C by weight) and predominantly Ni (8 to 11 wt %), Cr (17 to 20 wt %) and iron (the balance by weight).

The term “stainless steel” (commonly called “stainless”) is understood according to the invention to mean a steel, that is to say an alloy of metals comprising iron and carbon (generally less than 1.5%), said stainless steel generally comprising, and preferably according to the invention, chromium with a chromium content generally of 10.5% or higher. Said steel usually has a carbon content generally 1.2% or less. A stainless steel may also include other alloying constituents, in particular nickel,

The component according to the invention essentially differs from the supported active constituents of the known lithium accumulators (whether commercial or otherwise), which owe much to the open structure of the active electrode materials in order to allow reversible insertion of ions during cycling. Although not having a similar structure, the components according to the invention exhibit electrochemical activity in the presence of Li with high capacities.

The invention also relates to a process for manufacturing a component according to the invention, comprising at least one treatment of at least one material present in an electron collector, said material comprising at least one metal chosen from the transition metals of Groups 4 to 12 of the Periodic Table of the Elements. In general, according to a preferred method of implementing the invention, said treatment is chosen from high-temperature treatments in a reducing, neutral or oxidizing atmosphere. Said treatments are conventional treatments, known to those skilled in the art, and generally carried out in one or more gaseous media or in a molten-salt medium. The treatment may be a treatment in hydrogen at a temperature generally of 500 to 1000° C. preferably 600 to 800° C., for example about 700° C. Preferably, said treatment may thus be a treatment in air at a temperature of generally 600 to 1200° C., preferably 800 to 1150° C., for example about 1000° C. These temperatures are given merely by way of indication. A person skilled in the art is capable of adapting the temperature and the duration of the treatment depending on the case. This expression “treatment in hydrogen” or “treatment in air” is understood according to the invention to mean a treatment in the presence of at least one gaseous medium comprising hydrogen or air, the remainder possibly being another gas, such as nitrogen. For example, the treatment is carried out in a mixture comprising 90% nitrogen and 10% hydrogen or air (by volume).

The component according to the invention may be pretreated by at least one pretreatment which is generally at least one acid corrosion treatment and/or at least one chemical or physical or electrochemical deposition and/or at least one mechanical treatment and/or at least one treatment so as to modify the chemical composition thereof and/or at least one treatment so as to modify the developed area thereof.

The invention also relates to the use of at least one component, as described above, as an electrode.

The invention also relates to a supercapacitor comprising at least one component according to the invention or manufacturer according to the invention,

Such a supercapacitor may be in all forms of supercapacitor: hybrid, pseudo capacitor, or supercapacitor.

The invention furthermore relates to an electrochemical accumulator comprising at least one positive electrode (or cathode) and at least one negative electrode (or anode), characterized in that it includes at least one component according to the invention or manufactured according to the invention.

Preferably, such an electrochemical accumulator is a lithium accumulator.

Advantageously, said component acts as an electrode, preferably an anode. Hereinafter, in the laboratory examples, lithium is used as reference potential, and therefore what will serve as anode in the industrial accumulator is tested as a cathode in the laboratory example.

Said accumulator generally includes a separator, for example made of glass fiber, as is known to those skilled in the art.

In a first embodiment of the invention, said accumulator is a lithium metal accumulator. In this case, said accumulator generally includes at least one liquid electrolyte comprising at least one salt, the anode comprising lithium metal and said accumulator is characterized in that the cathode comprises said component, the cathode preferably consisting mainly of said component,

In this first embodiment, said salt is generally a lithium and/or ammonium salt, preferably a lithium salt.

In this first embodiment, the anode or negative electrode generally comprises lithium metal, and is preferably based on lithium metal, that is to say it comprises mainly lithium metal. However, more generally, the negative electrode may comprise lithium metal or a lithium alloy, as is known to those skilled in the art.

The liquid electrolyte generally comprises at least one salt, as is known to those skilled in the art, such as for example a lithium salt chosen from the group formed by LiCF₃SO₃, LiClO₄, LiN(C₂F₅SO₂)₂, LiN(CF₃SO₂)₂, LiAsF₆, LiSbF₆ and LiPF₆ and LiBF₄, and/or an ammonium salt such as (C₄H₉)₄NClO₄. Preferably, said salt is chosen from the group formed by LiCF₃SO₃, LiClO₄, LiPF₆ and LiBF₄.

In general, said salt is dissolved in an anhydrous organic solvent, generally consisting of mixtures of variable proportions of propylene carbonate, dimethyl carbonate and ethylene carbonate. Thus, said electrolyte generally comprises, as is known to those skilled in the art, at least one cyclic or acyclic, preferably cyclic, carbonate according to the invention., For example, said electrolyte is LP30, a commercial compound from Merck comprising EC (ethylene carbonate), DMC (dimethyl carbonate) and LiPF₆ salt, the solution being 1 molar in terms of salt and 50%/50% by weight in terms of solvent.

In a second embodiment of the accumulator according to the invention, said accumulator is a lithium ion accumulator. In this case, the electrolyte generally comprises at least one salt and the cathode or positive electrode comprises lithium, usually as lithium ion source, said accumulator being characterized in that the anode comprises said component, the anode preferably consisting mainly of said component.

In this second embodiment, said salt is generally a lithium and/or ammonium salt, preferably a lithium salt.

In this second embodiment, the cathode or positive electrode generally comprises lithiated insertion materials, which are Li⁺ ion sources, as is known to those skilled in the art. For example, said cathode comprises at least one lithium compound, such as LiCoO₂ or LiFePO₄, or a compound of the LiMX₂ type.

Accumulators of the lithium metal type are generally assembled for laboratory experimentation purposes in configurations of the button cell type. Lithium ion accumulators are generally assembled for laboratory experimentation purposes in configurations of the button cell type. To do this, the following stack is produced. Firstly, placed on the bottom of a button cell case is said component, on which the following are deposited in succession: 1) a separator, of the glass fiber separator type, imbedded with electrolyte; 2) a plastic foil (for example prepared according to the Bellcore technology—as described in example 4), containing a lithium-containing positive electrode material; then 3) an untreated steel disk; and 4) a metal spring. Thereafter, a lid is added on top of the button cell and the whole assembly is mechanically sealed, usually by means of a suitable crimping device,

A lithium-ion accumulator for industrial use is generally assembled from the following stack, deposited on said component, in succession: 1) a separator, of the glass fiber separator type; 2) a plastic foil (for example prepared according to the Bellcore technology—as described in example 4), containing a lithium-containing positive electrode material; 3) an aluminum foil; 4) a plastic foil (for example prepared to the Bellcore technology—as described in the example; and then 5) a separator, of the glass fiber separator type. The whole assembly is bound up over a specified length and then said component is introduced into a metal cup. Said component is in direct contact with the metal cup. The lid of the cup is welded onto the aluminum foils. The cup is then filled with liquid electrolyte under vacuum so as to impregnate the various films. The lid is then crimped onto the cup.

Finally, the invention relates to the use of an accumulator as described above for a hybrid vehicle, for an electric vehicle, for a stationary application (i.e. electrical backup or energy storage for renewable energy) or portable equipment. A hybrid vehicle is a vehicle that combines an electric motor with an internal combustion engine.

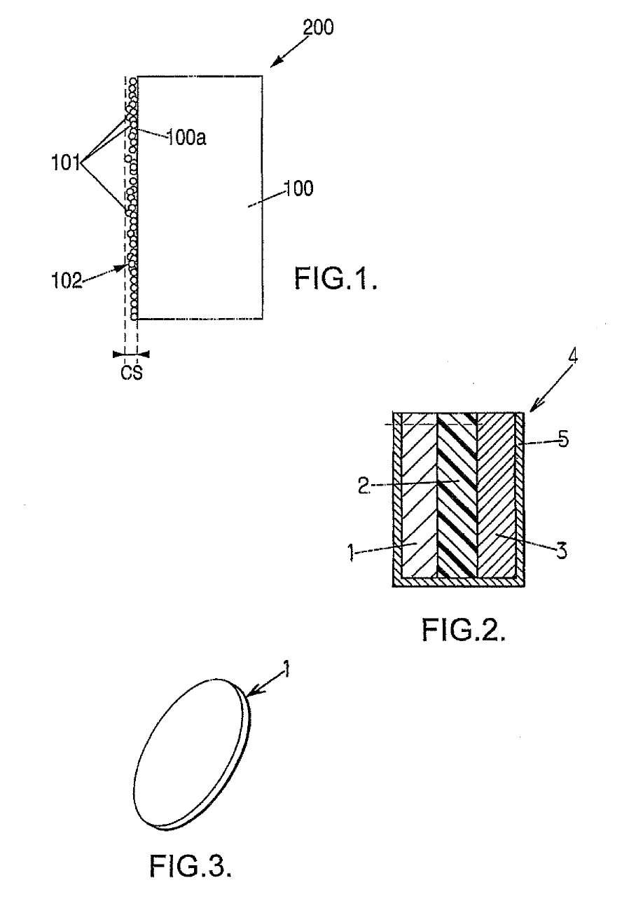

The invention will be better understood and other features and advantages will become apparent on reading the following description, given by way of nonlimiting example and with reference to FIGS. 1 to 11.

FIG. 1 shows a schematic sectional view of a component according to the invention.

FIG. 2 shows a schematic sectional view of a lithium-metal accumulator according to the invention comprising a component according to the invention

FIG. 3 shows schematically, in a perspective view, one of the elements of FIG. 2, which is the component according to the invention,

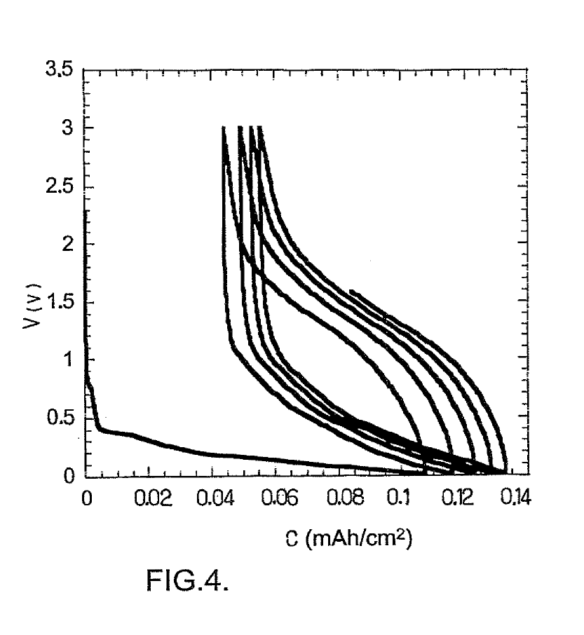

FIG. 4 shows, for an accumulator according to the invention of FIG. 2, the potential V (in volts) relative to that of the Li/Li⁺ pair as a function of the capacity (C in mAh/cm²) of said accumulator at 55° C.

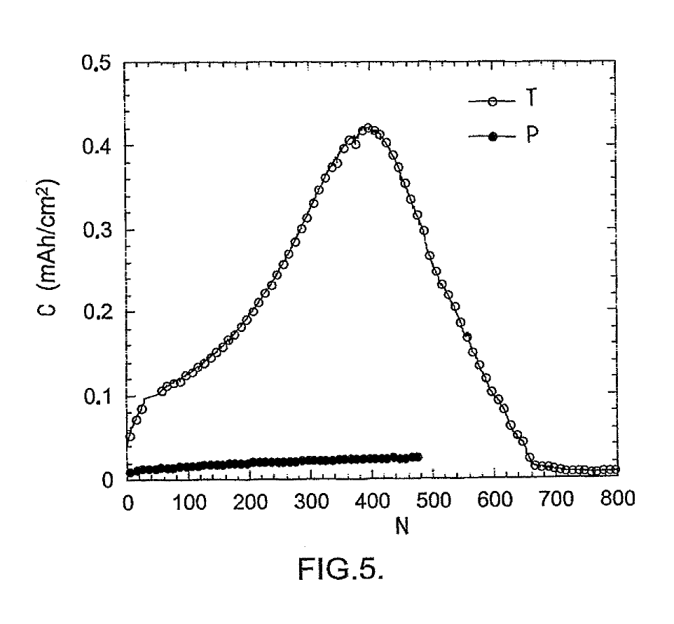

FIG. 5 shows, for the same accumulator according to the invention as that studied in FIG. 4, the capacity (C in mAh/cm²) of said accumulator and also the capacity of a comparative accumulator as a function of the number of cycles (N) at 55° C.

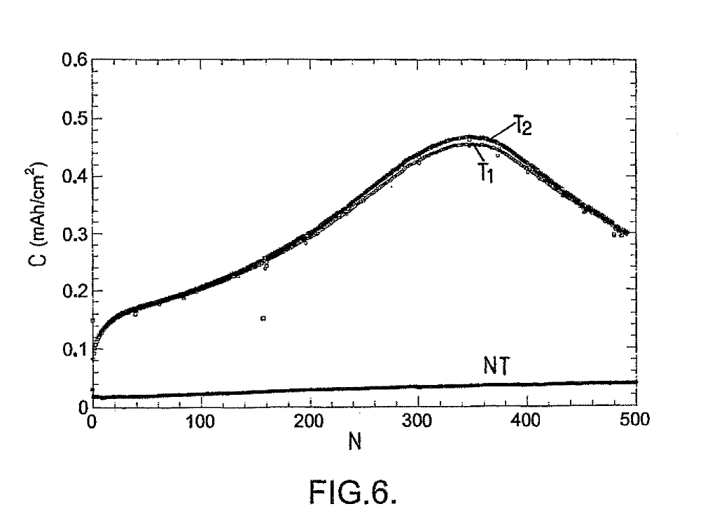

FIG. 6 shows, for an accumulator according to the invention of FIG. 2, which is different from that studied in FIGS. 4 and 5, the charge capacity (T₁) and the discharge capacity (T₂) of said accumulator (C in mAh/cm²) and also the capacity of a comparative accumulator as a function of the number of cycles (N).

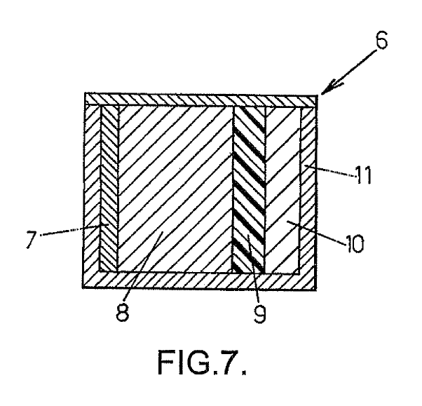

FIG. 7 shows a schematic sectional view of a lithium-ion accumulator according to the invention comprising a component according to the invention.

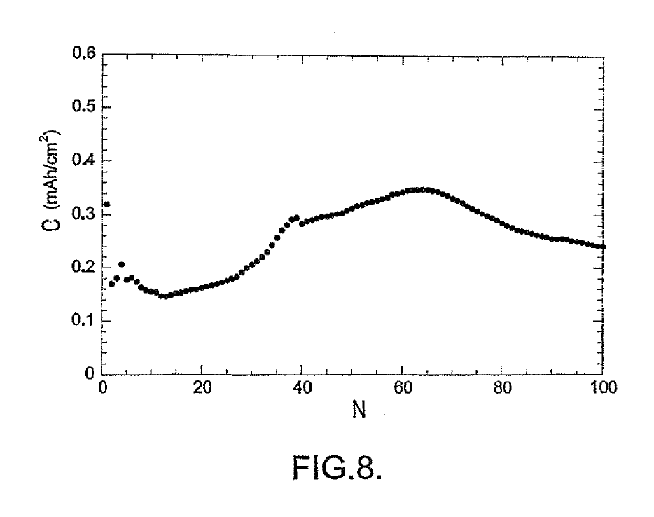

FIG. 8 shows, for a lithium-ion accumulator according to the invention, different from that studied in FIGS. 4 and 5, the capacity (C in mAh/cm²) of said accumulator as a function of the number of cycles (N).

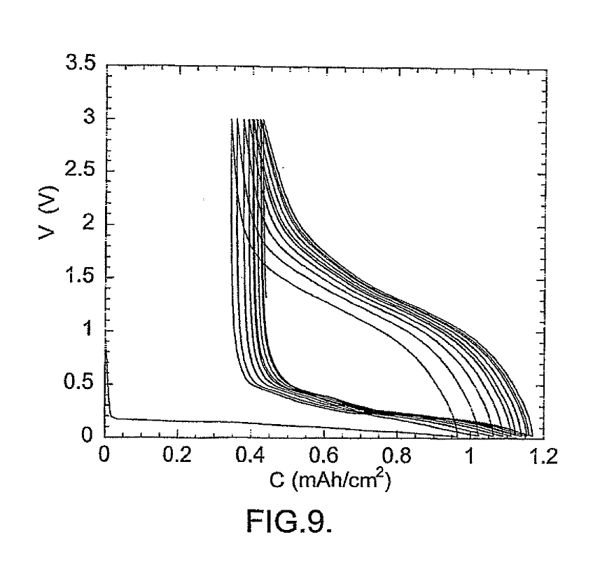

FIG. 9 shows, for an accumulator according to the invention, the potential V (in volts) relative to that of the Li/Li⁺ pair as a function of the capacity (C in mAh/cm²) of said accumulator at 55° C.

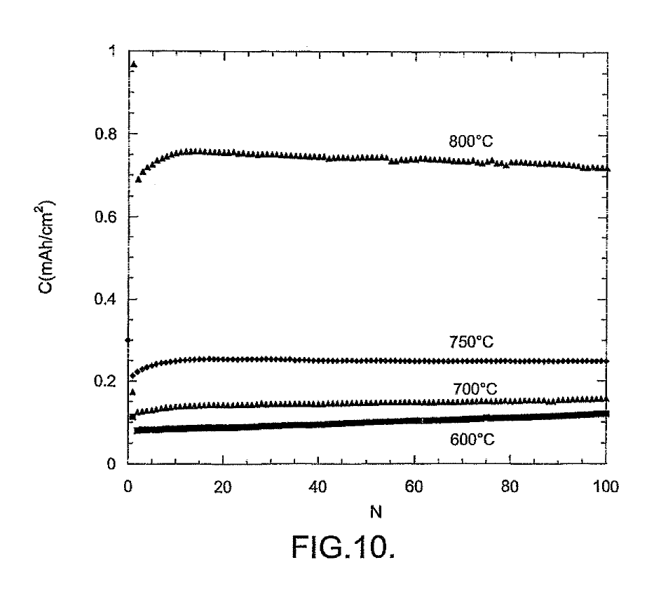

FIG. 10 shows the capacity C (in mAh/cm²) of four accumulators according to the invention as a function of the number of cycles (N).

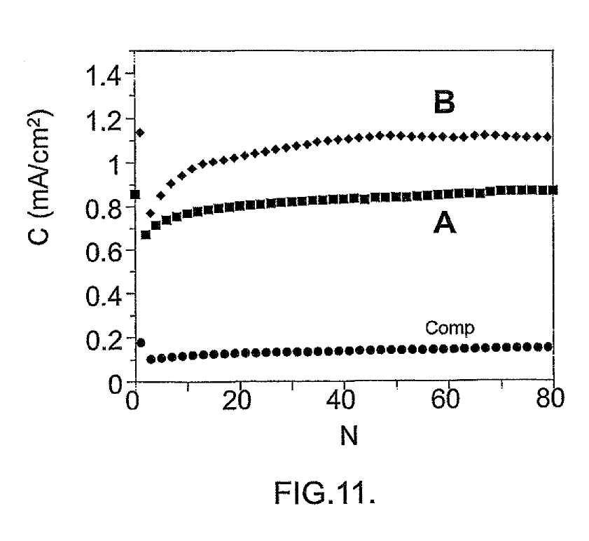

FIG. 11 shows the capacity C (in mAh/cm²) of accumulators (A and B) according to the invention as a function of the number of cycles (N) and also, for comparison, the capacity C (in mAh/cm²) of a comparative accumulator (Comp).

FIG. 1 shows a schematic sectional view of a component according to the invention. Such a component 200 comprises a collector 100, typically in the form of a disk seen on its edge, from which nanoparticles 101 of active material have been formed (these have been enlarged and arbitrarily indicated as being of identical size in order to simplify the schematic representation of FIG. 1). The combination 102 of nanoparticles 101 forms a layer 102 of maximum thickness CS on a surface 100a of the collector 100. The thicker this layer 102, the more the nanoparticles 101 can agglomerate (into agglomerates, not shown). This is achieved by treatment, for example in air at high temperature, of the collector 100 and in particular of its surface 100a. The collector 100 is typically made of stainless steel. Chromium (Cr), iron (Fe) and manganese (Mn), constituents of the collector 100, have reacted with oxygen (O₂) of the air to form oxides mainly based on chromium oxide in the form of nanoparticles 101. No external material has been added, such as a secondary electron conductor or a binder. However, the component 200 as such may serve as an electrode in an accumulator or a supercapacitor.

FIG. 2 shows a schematic sectional view of a lithium-metal accumulator 4 according to the invention. The accumulator 4 comprises an anode or negative electrode 3 (the active part), which is based on lithium metal, for example comprising, over its entire surface facing the electrolyte, a layer of Li metal, a part 2 which is a separator, for example made of glass fiber impregnated with a liquid electrolyte, which consists for example of LP30, and a positive electrode 1 consisting of a component 1 according to the invention placed in such a way that the nanoparticles face the part 2, The parts 1, 2 and 3 are disks seen in cross-section. The assembly is crimped in a container 5, for example of the button cell type, which includes a lid (not shown here).

FIG. 3 shows schematically, in a perspective view, one of the elements of FIG. 2, which is the component of circular shape according to the invention.

FIGS. 4 and 5 will be commented upon below in example 1.

FIG. 6 will be commented upon below in example 2.

FIG. 7 shows a schematic sectional view of a lithium-ion accumulator 6 according to the invention. The accumulator 6 comprises an anode or negative electrode 10 (active part) consisting of a collector 10 according to the invention, a part 9 which is a separator, for example made of glass fiber impregnated with a liquid electrolyte, which consists for example of LP30, a current collector 7 for the positive electrode, for example made of aluminum, and a cathode or positive electrode 8 containing a lithium-ion insertion material, for example LiFePO₄. The anode 10 is placed in such a way that the nanoparticles face the part 9. The parts 7, 8, 9 and 10 are disks seen in cross section,. The assembly is crimped in a container 11, for example of the button cell type.

FIG. 8 will be commented upon below in example 3.

FIGS. 9 and 10 will be commented upon below in example 4.

FIG. 11 will be commented upon below in example 5.

### EXAMPLES

The following examples illustrate the invention without in any way limiting the scope thereof.

### Example 1

A polished disk of AISI 304 stainless sold by Goodfellow, with a geometrical area of 1.8 cm² and a thickness of 0.5 mm, was taken. Its developed area was equal to its geometrical area, and therefore was 1.8 cm². Such a disk was heated in a nitrogen/10% hydrogen mixture with a temperature rise of 5° C. per minute for temperatures going from 25° C. up to 700° C. The temperature was maintained at 700° C. for 13 hours before being lowered to room temperature (generally about 20° C.) without a ramp. It was shown, by scanning microscopy of said polished AISI 304 disk before and after the heat treatment, that the surface of the disk was uniform in the case of the polished disk, whereas in the case of the polished then treated disk, it was observed that the surface of the disk contained particles with a size of about 50 to 100 nm. Such a polished and then treated disk had an estimated developed area of about 40 cm².

This polished and then treated disk therefore had, as a surface layer, a nanostructured film composed essentially of Cr₂O₃ and FeₓCr₁₋ₓCr₂O₄ (0≦x≦1) , said film resting on a surface of AISI 304 stainless. This disk was included in an accumulator 4 as shown in FIG. 2. Said accumulator 4 comprised, in a container 5, a polished and treated disk 1, which acted as positive electrode or cathode 1, an electrolyte part 2, which was LP30 impregnated in a glass fiber separator in disk form, and a lithium negative electrode or anode 3 in disk form.

FIG. 4 shows, for such an accumulator according to the invention of FIG. 2, the potential V (in volts) relative to that of the Li/Li⁺ pair as a function of the capacity (C in mAh/cm²) of said accumulator at 55° C. The electrochemical behavior of such a disk cycled at 55° C. with LP30 between 0.02 and 3 V with a current density of 0.16 mA/cm² may therefore be seen. The first discharge is characterized by a potential drop down to 0.4 V. After this drop, the potential/capacity curve starts by forming a small plateau that evolves toward a slowly descending potential curve. The polished and treated AISI 304 disk according to the invention therefore had a free surface of large area for the electrolyte. This surface acted as catalyst for the degradation of the electrolyte, which may partly explain the extra capacity. When the electrolyte has been completely consumed or when the electrode has been poisoned by the degradation products, the capacity drops virtually to 0.

The figure therefore shows that the electro-activity is substantial. This is because capacities of about 0.11 to 0.13 mAh/cm² at a current density of 0.16 mA/cm² can be obtained at 55° C. in the presence of the LP30 electrolyte impregnating a glass fiber separator. Continuing this calculation to the end, it may be seen that developed areas of 400 and 800 cm² would give capacities of 0.7 and 1.4 mAh/cm²₁, respectively.

FIG. 5 shows, for the same accumulator according to the invention as that studied above in the case of FIG. 4, the capacity (C in mAh/cm²) of said accumulator and also the capacity of a comparative accumulator (comprising the polished AISI 304 disk not subsequently treated (P)) as a function of the number of cycles (N) at 55° C. Said polished but not subsequently treated AISI 304 disk (P) was integrated into what was called a comparative accumulator in the same way as the polished and then treated disk (T) according to the invention. FIG. 5 clearly shows the variation of the capacity as a function of the number of cycles of an accumulator comprising the polished then treated AISI 304 disk (T) according to the invention and that of the comparative accumulator. It may be seen that there is a large difference in behavior between the comparative accumulator and the accumulator according to the invention. The capacity of the accumulator according to the invention comprising the polished then treated disk (T) has increased steadily up to about 400 cycles, then decreased up to about 600 cycles, whereas the capacity of the comparative example shows only a minute variation during cycling.

### Example 2

An unpolished AISI 304 stainless disk sold by Goodfellow, with a geometrical area of 1.8 cm² and a thickness of 0.5 mm, was taken. Its developed area was approximately equal to its geometrical area and was therefore about 1.8 cm². Such a disk was heated in a nitrogen/10% hydrogen mixture at a temperature rise of 5° C. per minute for temperatures going from 25° up to 700° C. The temperature was maintained for 13 hours at 700° C. before being lowered down to room temperature (generally about 20° C.) without a ramp. It was observed, by scanning microscopy of said unpolished AISI 304 disk before and after heat treatment, that the surface of the disk was approximately plane in the case of the unpolished and untreated disk (NT), whereas in the case of the unpolished then treated disk (charge curve T₁ and discharge curve T₂) it was observed that the surface of the disk contained particles of larger size than those of the initially polished then treated disk (T of example 1) ranging from 100 to 300 nm.

Such an unpolished then treated disk therefore had, as surface layer, a nanostructured film composed essentially of Cr₂O₃ and FeₓCr₁₋ₓCr₂O₄ (0≦x≦1), said film resting on an AISI 304 stainless surface. This disk was included in an accumulator 4 as shown in FIG. 2. Said accumulator 4 comprised a disk 1, which acted as positive electrode or cathode 1, an electrolyte 2, which was LP30, and a lithium negative electrode or anode 3.

FIG. 6 shows, for said accumulator according to the invention of FIG. 2, which is different from that studied in FIGS. 4 and 5, the charge capacity (T₁) and discharge capacity (T₂) of said accumulator (C in mAh/cm²) and also the capacity of a comparative accumulator (NT) (comprising an unpolished and untreated disk), as a function of the number of cycles (N). Said unpolished and untreated AISI 304 disk (NT) was integrated into an accumulator, termed the comparative accumulator, in the same way as the unpolished then treated disk (T₁ or T₂) according to the invention. The figure shows the electrochemical behavior of an accumulator comprising an unpolished and treated AISI 304 disk (T₁ or T₂) according to the invention at 55° C., cycled with LP30 between 0.02 and 3 V with a current density of 0.16 mA/cm². FIG. 6 shows the variation in the capacity as a function of the number of cycles of the accumulator according to the invention compared with that of the comparative accumulator (NT) obtained for said cycling. As in the case of example 1, the capacities were increased up to about 0.45 mAh/cm² after about 400 cycles.

It should be noted that it is possible in both cases to modify the size of the particles (and therefore the thickness of the surface layer) either by modifying the temperature conditions (i.e. the heating and/or cooling conditions) or by acting on the surface before the treatment, generally by a pretreatment method as described above.

TEM (transmission electron microscopy) measurements have indicated coarser nanoparticles and better defined contours for the accumulator comprising an unpolished then treated disk (T1 or T2) than for the accumulator comprising a polished then treated disk (T). In addition, EDS (energy dispersion spectroscopy for elemental microanalysis) analyses have seemed to indicate that, following the heat treatment, the surface has been greatly enriched with chromium and iron, with diffusion of nickel into the AISI 304 metal matrix.

### Example 3

An Li-ion electrochemical accumulator was assembled as a button cell so as to produce a button-type accumulator, comprising an unpolished AISI 304 disk treated according to the procedure described in example 2, as negative electrode an LP30-imbibed glass fiber separator and an electrode consisting of LiFePO₄ and carbon materials mixed in a polymer matrix as positive electrode (case of a plastic positive electrode). The positive electrode consisted of 72.4 wt % LiFePO₄, 7.85 wt % carbon and 19.75 wt % of a binder polymer, which was PVDF-HFP (polyvinyl DI fluoride/hexafluoro propylene). The component according to the invention thus acted as anode or negative electrode.

FIG. 8 shows, for such a lithium-ion accumulator according to the invention, different from that studied in FIGS. 4 and 5, the capacity (C in mAh/cm²) of said accumulator cycle between 0.01 and 3.43 V at 55° C., with a current density of 0.16 mA/cm² as a function of the number of cycles (N).

FIG. 8 shows that the behavior of this accumulator, of the lithium ion type, was identical to that of the previous accumulators, of the lithium metal type, with good reversibility, as was seen in FIG. 4 in the case of the accumulator of example 1. Thus, this novel electrode concept may be used for the assembly of lithium accumulators in variable configurations.

### Example 4

An SUS316L-type stainless disk, sold by Hohsen Corporation, 1.6 cm in diameter, unpolished and with a thickness of 0.5 mm, was cleaned with alcohol before being heated in a tube furnace, no longer in a nitrogen/hydrogen mixture as in examples 1 and 2, but in air. The heating was applied at a rate of 5° C. per min up to 800° C. and then maintained at this temperature for 13 h before being stopped. The cooling down to room temperature was carried out without a ramp.

The surface of the disk before treatment was shown to be approximately plane by scanning electron microscopy, whereas the disk heat-treated in air had octahedral (or diamond-shaped) particles of heterogeneous size, possibly up to 2000 nm, and also particles in the form of platelets about 10000 nm in diameter and 500 nm in thickness. The composition of the two types of particles was determined by transmission electron microscopy coupled to the EDS elemental analyzer. The octahedral particles were characterized by a phase of spinel structure with a composition close to Mn_{0.96}Fe_{0.03}Cr₂O₄, whereas the particles in platelet form corresponded to the well-crystallized Cr₂O₃ phase. We were able to note here that the phase of spinel structure was enriched with manganese compared to examples 1 and 2.

Such a stainless steel disk, unpolished then treated in air at 800° C., therefore had, as surface layer, a film essentially consisting of oxides mainly based on chromium, such as Cr₂O₃ and Mn_{0.96}Fe_{0.03}Cr₂O₄. This disk was included in an accumulator 4, as shown in FIG. 1. Said accumulator 4 comprised a disk 1, which acted as positive electrode or cathode 1, an electrolyte 2, which was LP30, and a lithium negative electrode or anode 3.

FIG. 9 shows, for such an accumulator according to the invention, the potential V (in volts) relative to that of the Li/Li⁺ pair as a function of the capacity (C in mAh/cm²) of said accumulator at 55° C. The cycling was carried out with LP30 between 0.02 and 3 V with a current density of 0.15 mAh/cm². The first discharge was characterized by a drop in potential down to about 0.15 V, then the potential curve formed a pseudo-plateau, descending slowly before reaching a capacity of about 0.96 mAh/cm². Compared with examples 1 and 2, the electroactivity was increased by a factor of slightly greater than 3 for an almost identical applied current density

FIG. 10 shows the capacity C (in mAh/cm²) of such an accumulator according to the invention as a function of the number of cycles (N), and also the capacities of three other accumulators according to the invention which are identical to the previous one except for the fact that the heat treatment temperatures in air of the stainless disks were modified, namely: 600° C., 700° C. and 750° instead of 800° C. We have noted a large difference in capacity values between the various accumulators, underlining the influence of the treatment temperature on the electroactivity of the surface layer of the steel disk. Several tens of degrees have thus made it possible here to increase the electroactivity by a factor of 3.

### Example 5

An SUS316L stainless disk, sold by HOHSEN Corporation, with a diameter of 1.6 cm and a thickness of 0.5 mm, was chemically pretreated for the purpose of increasing the surface porosity and thus the electrochemically active area. The pretreatment was carried out in three steps: 1) cleaning in THF (tetrahydrofuran); 2) an activation step of 5 minutes in a sulfuric acid solution (5 vol %); and 3) chemical oxidation in a suitable acid solution at 60° C. The bath was made up of sulfuric acid (0.93M), Na₂S₂O₃ (0.0006M) and propargylic alcohol C₃H₄O (0.05M). The Na₂S₂O₃ and C₃H₄O acted as activator and cathode inhibiter, respectively. The duration of the last step 3) was set either at 5 minutes, resulting in the specimen denoted by A in FIG. 11, or 20 minutes, resulting in the specimen denoted by B in this same FIG. 11. Scanning electron microscopy characterization revealed a drastic change in the surface morphology of the treated specimens, with the appearance of a highly porous surface. Measurements of the surface area of the treated disks carried out by the BET technique using krypton as absorbent gas gave values of 6 m²/m² and 13 m²/m² for specimens A and B, respectively.

These two chemically treated disks A and B were then subjected to a heat treatment according to the invention, in a stream of a nitrogen/hydrogen (10%) mixture as in examples 1 and 2. The heating was carried out at a rate of 5° C. per min. up to 700° C. and then maintained at this temperature for 13 h before being stopped. The cooling down to ambient temperature was carried out without a ramp in a stream of this same gas.

The scanning electron microscopy characterization of these chemically and then thermally treated specimens A and B also revealed a highly porous surface. Excluding the appearance of small metal nodules, the heat treatment did not seem to induce a profound change in the surface porosity. The BET surface area measurements carried out also revealed no significant differences.

The stainless steel disks denoted by A and B, chemically treated and then thermally treated in a stream of a nitrogen/hydrogen mixture at 700° C., had, as surface layer, a film essentially consisting of oxides mainly based on chromium, such as Cr₂O₃ and FeₓCr₁₋ₓCr₂O₄ (0≦x≦1). Each of these disks was included in an accumulator 4 as shown in FIG. 1. Said accumulator 4 comprised a disk 1, which acted as positive electrode or cathode 1, an electrolyte 2, which was LP30 and a lithium negative electrode or anode 3.

FIG. 11 shows the capacity (in mAh/cm²) of an accumulator containing the disk A and an accumulator containing the disk B as a function of the number of cycles (N), and also, for comparison, the capacity of an accumulator whose SUS316L disk was not subjected to chemical treatment before the heat treatment in a stream of nitrogen/hydrogen mixture at 700° C. The cycling was carried out with LP30, at 55° C., between 0.02 and 3 V with a current density of 0.15 mAh/cm². We have noted a large difference in the capacity values between the accumulator not containing a chemically pretreated disk and both the accumulator containing the disk A and the accumulator containing the disk B which have a large surface area. A chemical pretreatment has therefore made it possible to increase the capacities by a factor of about 5. FIG. 11 also emphasizes the influence of the third step of the chemical pretreatment: the capacity goes from 0.8 to 1.1 mAh/cm² by increasing the duration of this treatment from 5 minutes to 20 minutes.

1. A component comprising at least one electron collector and electrochemically active material, said active material containing at least one metal belonging to the group of transition metals of Groups 4 to 12 of the Periodic Table of the Elements, preferably belonging to the group consisting of nickel, cobalt, manganese, copper, chromium and iron, even more preferably chromium, the active material having been at least partly, preferably almost entirely, formed from the collector and the active material being at least partly, preferably almost entirely, on the surface (100a) of the electron collector, and at least some of the active material comprising at least nanoparticles of at least one transition metal compound or agglomerates of said nanoparticles, the nanoparticles having a mean size of 1 to 1000 nm, preferably 10 to 300 nm, and the agglomerates of nanoparticles having a mean size of 1 to 10000 nm, preferably 10 to 3000 nm.

2. The component as claimed in claim 1, wherein the transition metal compound is an inorganic transition metal compound, preferably selected from the group consisting of transition metal chalcogenides and transition metal halides, even more preferably selected from the group consisting of the transition metal chalcogenides.

3. The component as claimed in claim 2, wherein the inorganic transition metal compound is a transition metal oxide.

4. The component as claimed in claim 2, wherein the transition metal compound is of formula MₓO_{y}, in which 1≦x≦3 and 1≦y≦5, preferably 1≦y≦4, and M is at least one transition metal, the transition metal compound preferably being of formula selected:
from the group consisting of spinel type structures AB₂O₄, where A is at least one transition metal selected from the group consisting of Fe, Mn, Cr, Ni, Co and Cu, and B is at least one metal selected from the group consisting of Fe, Cr and Mn; and/or
from the group consisting of sesquioxides M′₂O₃, where M′ is at least one transition metal selected from the group consisting of Fe, Mn, Cr, Ni, Co and Cu, the transition metal compound being even more preferably of formula Fe_{x′}Cr_{y′}Mn_{z′}O₄, where: 0≦x′≦1, 0≦z′≦1, and x′+y′+z′=3, and/or Cr₂O₃.

5. The component as claimed in claim 1, at least partly, and preferably entirely, comprising a surface layer formed predominantly from at least one transition metal compound, preferably an inorganic one, the surface layer mainly consisting of nanoparticles or agglomerates of nanoparticles of at least one transition metal compound, the nanoparticles and the agglomerates of nanoparticles being as defined in claim 1.

6. The component as claimed in claim 1, wherein said surface layer has a thickness of 30 to 15000 nm, preferably 30 to 12000 nm.

7. The component as claimed in claim 1, such that the collector comprises stainless steel.

8. A process for manufacturing a component as claimed in claim 1, comprising at least one treatment of at least one material present in an electron collector, said material comprising at least one metal selected from the transition metals of Groups 4 to 12 of the Periodic Table of the Elements, said treatment being selected from high-temperature treatments in a reducing, neutral or oxidizing atmosphere.

9. The use of at least one component as claimed in claim 1, as an electrode.

10. A supercapacitor comprising at least one component as claimed in claim 1.

11. An electrochemical accumulator, preferably a lithium accumulator, comprising at least one positive electrode (or cathode) and at least one negative electrode (or anode), characterized in that it includes at least one component as claimed in claim 1.

12. The accumulator as claimed in claim 1, comprising at least one liquid electrolyte comprising at least one salt, the anode comprising lithium metal, said accumulator being characterized in that the cathode comprises said component, the cathode preferably consisting essentially of said component.

13. The accumulator as claimed in claim 11, wherein the electrolyte comprises at least one salt, and the cathode comprises lithium, said accumulator being characterized in that the anode comprises said component, the anode preferably consisting essentially of said component.

14. The use of an accumulator as claimed in claim 11 for a hybrid vehicle, an electric vehicle, a stationary application or for portable equipment.
